(19) United States
(12) Patent Application Publication
(10) Pub. No.: US 2024/0232383 A9
(43) Pub. Date: Jul. 11, 2024

(54) SEMICONDUCTOR DEVICE AND METHOD OF MANAGING SECRET INFORMATION

(71) Applicant: RENESAS ELECTRONICS CORPORATION, Tokyo (JP)

(72) Inventors: Akira HAMAGUCHI, Tokyo (JP); Yuichi IWAYA, Tokyo (JP)

(21) Appl. No.: 18/449,968

(22) Filed: Aug. 15, 2023

(30) Foreign Application Priority Data
Oct. 20, 2022 (JP) 2022-168177

(51) Int. Cl. G06F 21/57; G06F 21/79

(52) U.S. Cl. CPC G06F 21/577; G06F 21/79

(57) ABSTRACT

This invention provides a method of managing secret information that ensures that key information in the discard phase can be invalidated and that the system cannot be started. In method of managing secret information in a semiconductor device, the semiconductor device has an OTP (One Time Programmable) module, a security module and a processor. The OTP module further has an OTP memory for storing a secret information and a lifecycle flag for defining an operation phase and a discard phase, a sequencer for reading information stored in the OTP memory and a register for storing the information read by the sequencer. The security module performs a process by the secret information. The processor requests the process to the security module when changing the operation phase to the discard phase and sends a request to the security module to invalidate the secret information.

### CROSS-REFERENCE TO RELATED APPLICATIONS

The disclosure of Japanese Patent Application No. 2022-168177 filed on Oct. 20, 2022, including the specification, drawings and abstract is incorporated herein by reference in its entirety.

### BACKGROUND

The present invention relates to a method of managing secret information and a semiconductor device.

Recently, in the automotive field, with the development of connected and ADAS (Advanced Driver Assistance Systems), vehicle-mounted electronic devices such as vehicle-mounted cameras, drive recorders, and car navigation systems have come to be installed in many cases. In vehicle-mounted electronic devices, it is necessary to securely store an encryption key that encrypts the user's private information and the encryption key that encrypts communication with other devices. Secret data such as encryption keys is generally written in an OTP (One Time Programmable) memory that cannot be accessed by software and is robustly protected. Key management of vehicles also requires consistent security assurance during the vehicle lifecycle phase.

Incidentally, in the Patent Document 1, it is described that an encrypted game program captured from the outside is decrypted using a key previously stored in a storage, after writing a decrypted game program to a non-volatile storage, the key is changed to an erasure or non-meaningful code.

There are disclosed techniques listed below.
[Patent Document 1] Japanese Unexamined Patent Application Publication No. 2000-137609

### SUMMARY

In Patent Document 1, it is assumed that the encryption key to be used only once to write the game program to the safely ROM in the manufacturing phase. On the other hand, in the vehicle-mounted electronic device, it is assumed that the encryption key is used repeatedly in the operation phase.

In other words, it means that the encryption key of Patent Document 1 is extinguished in the operation phase.

Therefore, in the discard phase after the operation phase, invalidation of the encryption key is required so that the encryption key is exploited by a malicious third party and the private data of the user stored in the vehicle is not restored. The object of present disclosure is to define a discard phase as the state of the vehicle's lifecycle, and when the vehicle moves to the discard phase, invalidates the secret information stored in the OTP memory and stops subsequent system operations.

Other objects and novel features will become apparent from the description of this specification and the accompanying drawings.

According to one embodiment, a method of managing secret information is such that when a processor recognizes that the state of the vehicle's lifecycle is changed from the operation phase to the discard phase, the processor requests a security module to change from the operation phase to the discard phase. Then the security module invalidates the secret information and stops the operation of the semiconductor device.

According to one embodiment, it is possible to invalidate the key information in the discard phase reliably and it is impossible to activate the system. In other words, it becomes impossible to extract the key information by a malicious third party, it is possible to safely protect the assets of the user.

### BRIEF DESCRIPTION OF THE DRAWINGS

FIG. 1 is a block diagram showing a configuration of a semiconductor device according to a first embodiment.

FIG. 2 is a diagram showing a configuration example of a lifecycle flag of the semiconductor device according to the first embodiment.

FIG. 3 is a flowchart for moving from the operation phase to the discard phase in the semiconductor device according to the first embodiment.

FIG. 4 is a flowchart of a discard phase in the semiconductor device according to the first embodiment.

FIG. 5 is a flowchart of a modification of the discard phase in the semiconductor device according to the first embodiment.

FIG. 6 is a block diagram showing a configuration of a modification of the semiconductor device according to the first embodiment.

FIG. 7 is a block diagram showing a configuration of a semiconductor device according to a second embodiment.

FIGS. 8A and 8B are a flowchart for moving from the operation phase to the discard phase in the semiconductor device according to the second embodiment.

FIG. 9 is a flowchart of a discard phase in the semiconductor device according to the second embodiment.

### DETAILED DESCRIPTION

For clarity of explanation, the following description and drawings are appropriately omitted and simplified. In addition, the elements described in the drawings as functional blocks for performing various processes can be configured as CPU (Central Processing Unit), memories, and other circuits in terms of hardware, and are realized by programs loaded into the memories in terms of software. Therefore, it is understood by those skilled in the art that these functional blocks can be realized in various forms by hardware alone, or a combination of hardware and software thereof, and the present invention is not limited to any of them. In the drawings, the same elements are denoted by the same reference numerals, and a repetitive description thereof is omitted as necessary.

### (Description of the Semiconductor Device According to the First Embodiment)

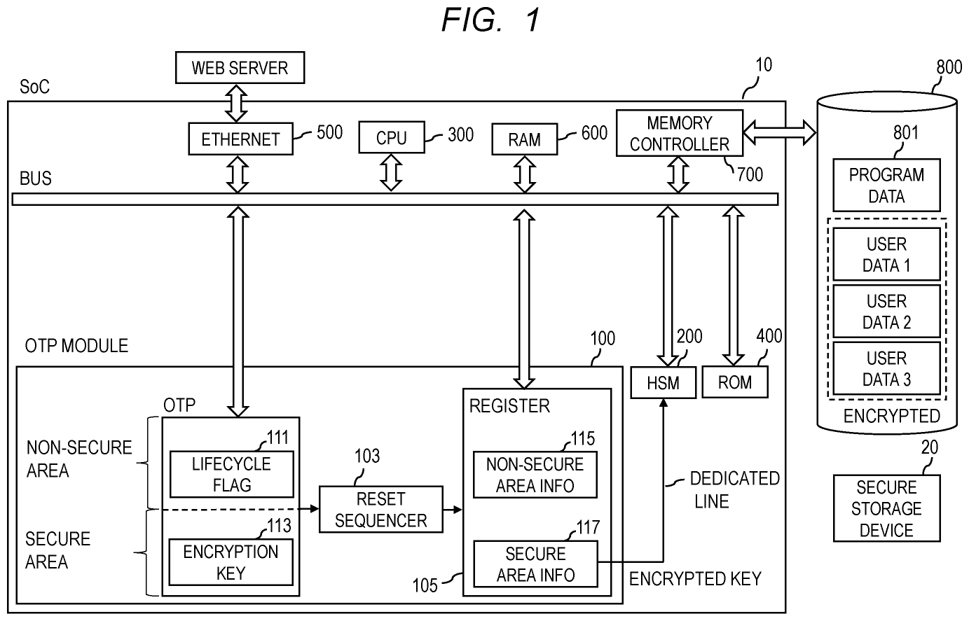

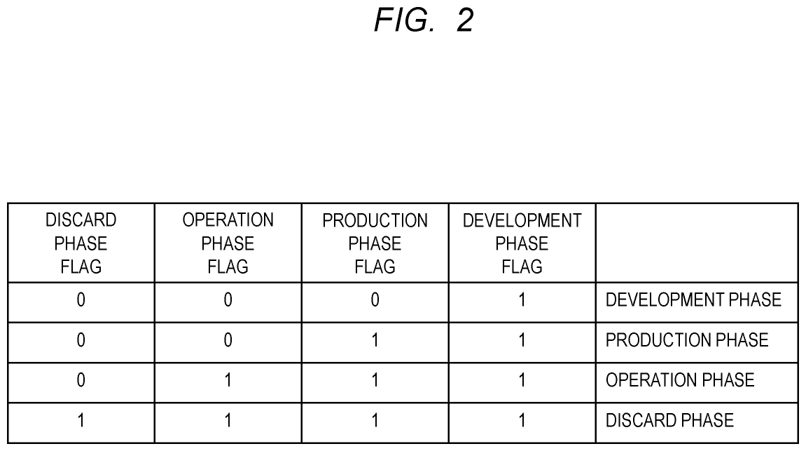

FIG. 1 is a block diagram showing a configuration of a semiconductor device according to the first embodiment. FIG. 2 is a diagram showing a configuration example of a lifecycle flag of the semiconductor device according to the first embodiment. Referring to FIGS. 1 and 2, a semiconductor device according to the first embodiment will be described.

A semiconductor device (SoC (System on a Chip)) 10 encrypts the user data from Web servers and stores the information in an external storage 20. The semiconductor device 10 includes an OTP module 100, an HSM (Hardware Security Module) 200, a CPU (Central Processing Unit) 300, a ROM (Read Only Memory) 400, an Ethernet 500, a RAM (Random Access Memory) 600, and a memory controller 700.

The OTP module 100 includes an OTP memory 101, a reset sequencer 103, and a register 105. The OTP memory 101 is separated into a non-secure area and a secure area. The non-secure area stores a lifecycle flag 111. The secure area stores an encryption key (secret information) 113. The non-secure area is readable/no-writable by the CPU 300 and no-readable/writable by the HSM 200. The secure-area is no-readable/writable by the CPU 300 and readable/no-writable by the HSM 200, it is well protected.

The reset sequencer 103 is a hardware sequencer that actively reads the OTP memory 101 only once when the power is turned on and reset.

The register 105 stores the data of the OTP memory 101 read by the reset sequencer 103. The register 105 stores non-secure area information 115 and secure area information 117. The non-secure area information 115 stored in the register 105 can be read only from the CPU 300 and the HSM 200. The register 105 is connected to other modules by a dedicated line, and the secure area information 117 is exchanged through the dedicated line. In the first embodiment, the secure area information 117 is the encryption key and the register 105 is connected to the HSM 200.

The HSM 200 is an enhanced tamper-resistant hardware device that secures the encryption process by protecting and managing the keys for encrypting data, decrypting data and generating digital signatures and certificates. The HSM 200 is connected to the register 105 by a dedicated line and the secret, which is the encryption key, is transmitted. The HSM 200 uses the transmitted private information to read the encrypted information in the external storage 20.

The CPU 300 is a processor that requires the HSM 200 to process and recognizes the moving from the operation phase to the discard phase. When the CPU 300 recognizes that the moving condition from the operation phase to the discard phase has been satisfied in the HSM 200, it requests the HSM 200 to move from the operation phase to the discard phase. Further, the CPU 300 also controls the entire semiconductor device 10. For example, the CPU 300 expands the software stored in the external storage 20 to the RAM 600 to process the information.

The ROM 400 is a storage device that can only read the recorded information. The ROM 400 stores information that should not be overwritten, such as BIOS and firmware, and information that does not need to be overwritten. Firmware is software incorporated in the semiconductor device 10, and controls the basic control of the circuit and the device inside the main body. The firmware is immediately deployed after the activation of the semiconductor device 10 and starts the control.

The Ethernet 500 is a communication standard used to exchange signals over computer networks. Here, the Ethernet 500 is used by the semiconductor device 10 to communicate information with the outside.

The RAM 600 temporarily stores the information/processing results read from the external storage 20 when the semiconductor device 10 is operating. The information stored in the RAM 600 disappears when the power is turned off. For example, the RAM 600 has a function of decrypting and temporarily storing the encrypted data stored in the external storage 20.

The memory controller 700 is a function or LSI (Large Scale Integration) that controls the interface of the main memory, such as the reading and writing of data in the RAM 600

The system of the first embodiment includes a secure storage device as the external storage 20. The external storage 20 includes program data 801 which is read into the CPU 300 and deployed on the RAM 600 to perform the processing. In addition, the external storage 20 stores the user data 1, the user data 2, and the user data 3 encrypted with the encryption key.

FIG. 2 shows an example of the structure of the lifecycle flag. The lifecycle flag defines the development, manufacturing, operation, and discard phases as follows: Development phase: Encryption keys in the OTP memory are blank.

Manufacturing phase: Storing encryption keys in the OTP memory.
Operation phase: Updating encryption keys in the OTP memory is prohibited.
Discard Phase: Invalidating encryption keys in the OTP memory.
The lifecycle flag moves to the next phase when 1 is added.

Therefore, the lifecycle does not return.

### (Description of a Method of Managing Secret Information of a Semiconductor Device According to the First Embodiment)

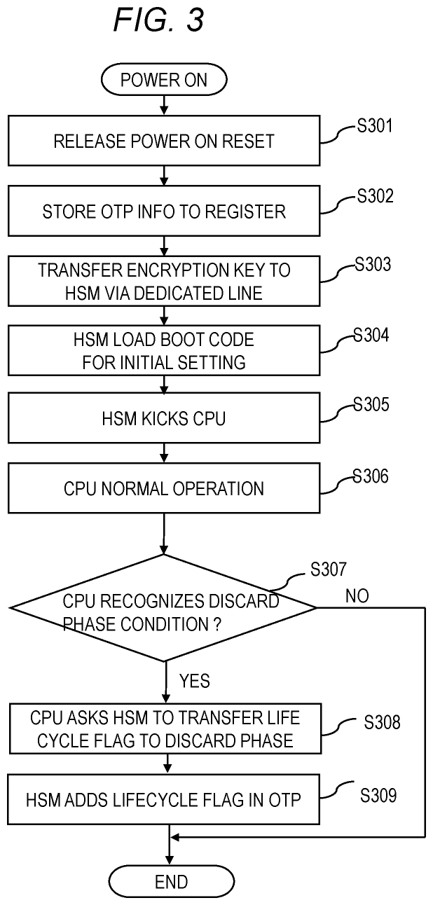

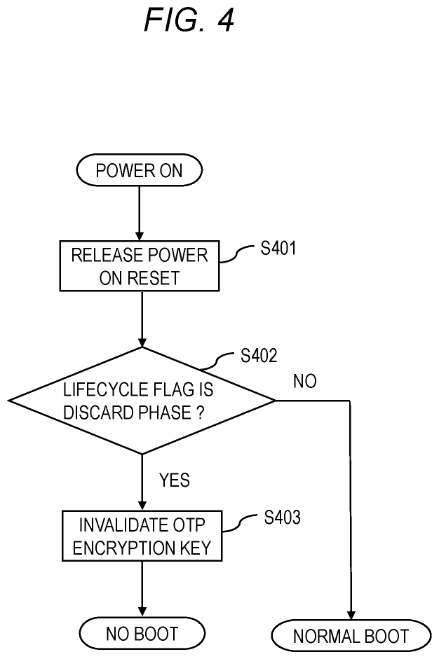

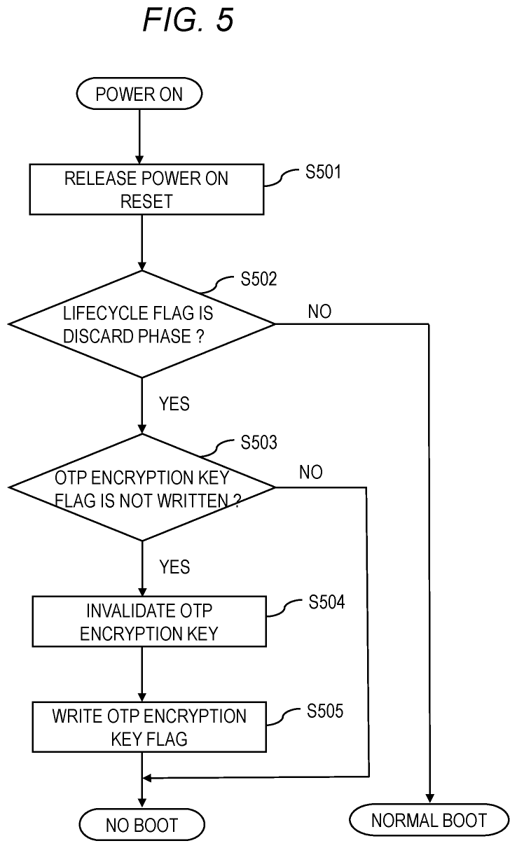

FIG. 3 is a flowchart for moving from an operation phase to a discard phase in a semiconductor device according to the first embodiment. FIG. 4 is a flowchart of a discard phase of a management method of secret information of a semiconductor device according to the first embodiment. FIG. 5 is a flowchart of a modification of the discard phase of the management method of the secret information of the semiconductor device according to the first embodiment. Referring to FIGS. 3 to 5, a method of managing secret information of the semiconductor device according to the first embodiment will be described.

As shown in FIG. 3, in the operation phase, the reset is released by turning on the power to the semiconductor device 10 (step S301). Next, the reset sequencer 103 of the OTP module 100 stores the information of the OTP memory 101 in the register 105 in the OTP module 100 (step S302). The register 105 then transfers the encryption key 113 to the HSM 200 on a dedicated line (step S303). The HSM 200 loads the boot code from the ROM 400, reads the lifecycle flag 111 of the OTP memory 101, and recognizes that it is in the operational phase. Thereafter, the HSM 200 performs initialization of the system of the semiconductor device 10 (step S304). The HSM 200 develops a CPU 300 program from the external storage 20 to the RAM 600 inside the semiconductor device 10 and kicks the CPU 300 (step S305). The CPU 300 starts normal operation (step S306).

When the CPU 300 recognizes the predetermined condition of the discard phase (step S307), it requests the HSM 200 to move from the operation phase to the discard phase (step S308). The HSM 200 adds the lifecycle flag 111 of the OTP memory 101 and terminates (step S309).

As shown in FIG. 4, in the discard phase, the reset is released by turning on the power in the semiconductor device 10 (step S401). Next, the reset sequencer 103 of the OTP module 100 stores the information of the OTP memory 101 in the register 105 in the OTP module 100. The HSM 200 loads the boot code of a firmware from the ROM 400, reads the lifecycle flag 111 in the OTP memory 101, and recognizes that it is in the discard phase (step S402). Then the HSM 200 overwrites the encryption key 113 in the OTP memory 101 with a random value or zero value (step S403). By stopping the subsequent process, the HSM 200 can stop the operation of the semiconductor device 10.

Thus, in the discard phase, each time power is turned on, the encryption key 113 of the OTP memory 101 is overwritten with a random value or a zero value. Therefore, if the power is turned off while the encryption key 113 is being overwritten and a write failure occurs, the write failure can be recovered by overwriting the encryption key the next time the power is turned on.

FIG. 5 shows a flowchart of a modification of the discard phase. As shown in FIG. 5, the power is turned on the semiconductor device 10 to reset release (step S501). Then it is determined whether or not it is the discard phase (step S502). In the discard phase, the invalidation flag of the encryption key 113 in the OTP memory 101 is determined whether or not it has been written (step S503). For example, the invalidation flag of the encryption key may be appended to the lifecycle flag shown in FIG. 2. If the power is turned on for the first time in the discard phase or if the power is turned off while overwriting the encryption key, the encryption key is invalidated again because the invalidation flag of the encryption key is not written (step S504).

Then the HSM 200 writes the invalidation flag of the encryption key if the invalidation flag of the encryption key has not been written (step S505). Thereafter, by stopping the subsequent process, the HSM 200 stops the operation of the semiconductor device 10. By setting the invalidation flag of the encryption key, it can be recognized that the encryption key of the OTP memory is surely invalidated.

### (Description of a Modification of the Semiconductor Device According to the First Embodiment)

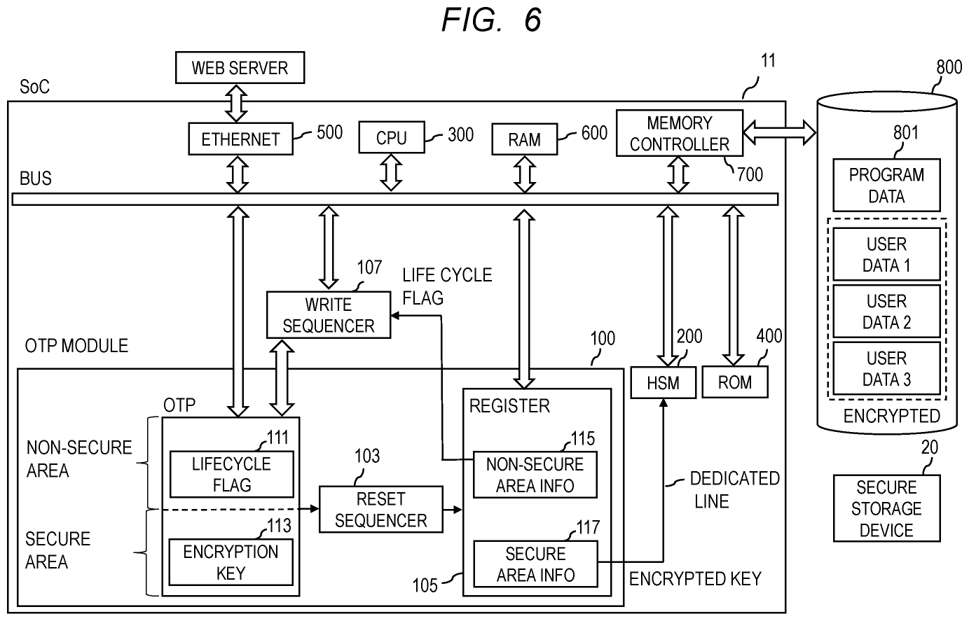

FIG. 6 is a block diagram showing a configuration of a modification of the semiconductor device according to the first embodiment. Referring to FIG. 6, a modification of the semiconductor device according to the first embodiment will be described.

In the first embodiment, the secure area is writable by the HSM 200. As shown in FIG. 6, the semiconductor device 11 of this modification includes a write sequencer 107. The write sequencer 107 may overwrite the encryption key of the secure area based on the instructions of the HSM 200. However, if the lifecycle flag is the operation phase, the write sequencer 107 is invalidated. Then, if the lifecycle flag is in the discard phase, the write sequencer 107 is validated for functionality. Thus, the HSM 200 could not update the encryption key 113 during the operation phase, and the integrity of the encryption key could be more robust.

### (The Semiconductor Device According to the Second Embodiment)

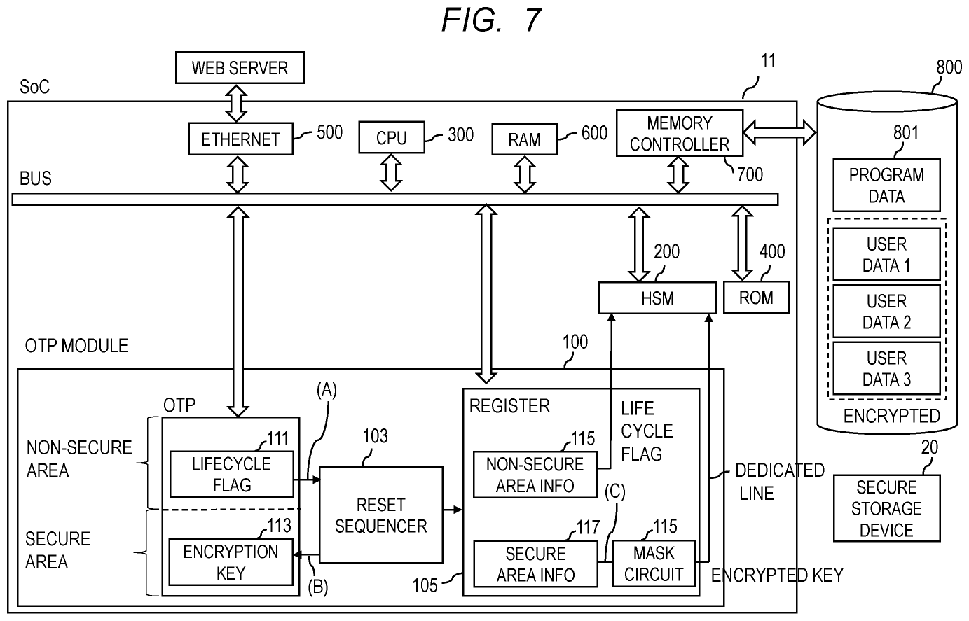

FIG. 7 is a block diagram showing a configuration of a semiconductor device according to the second embodiment. Referring to FIG. 7, a semiconductor device according to a second embodiment will be described.

The semiconductor device 12 according to the second embodiment, the function of the semiconductor device 10 and the reset sequencer 103 of the first embodiment are different. The semiconductor device 12 according to the second embodiment includes a mask circuit 119 in the register 105.

The reset sequencer 103 has a function of actively reading out the OTP memory 101 only once after power is inputted to the semiconductor device 12 ((A) in FIG. 7). The reset sequencer 103 has a function of invalidating the encryption key by requesting to invalidate the encryption key (discard phase request) of the OTP memory 101 from the HSM 200 ((B) in FIG. 7). The reset sequencer 103 has a function of transferring data for masking the encryption key 113 to the mask circuit 119 in the register 105 ((C) in FIG. 7).

The mask circuit 119 in the register 105 stores data to mask the data of the secret information such as the encryption key 113 of the OTP memory 101 read by the reset sequencer 103.

With such a configuration, invalidating of the encryption key can be performed by a hardware sequencer, and the resistance of non-invasive attacks such as fault attacks can be improved. The mask circuit also prevents the use of the encryption key after moving to the discard phase, since the use of the encryption key becomes unavailable, even during the period from the request to invalidate the encryption key to the reset.

### (Description of a Method of Managing Secret Information of a Semiconductor Device According to the Second Embodiment)

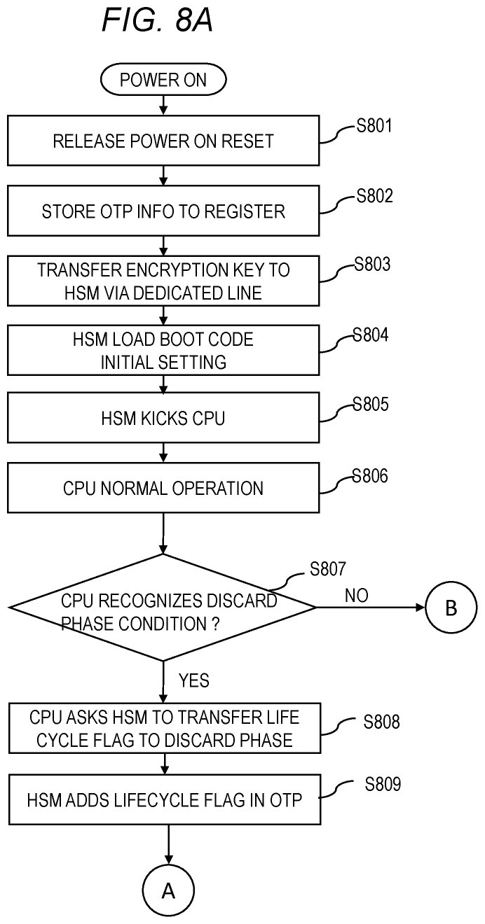

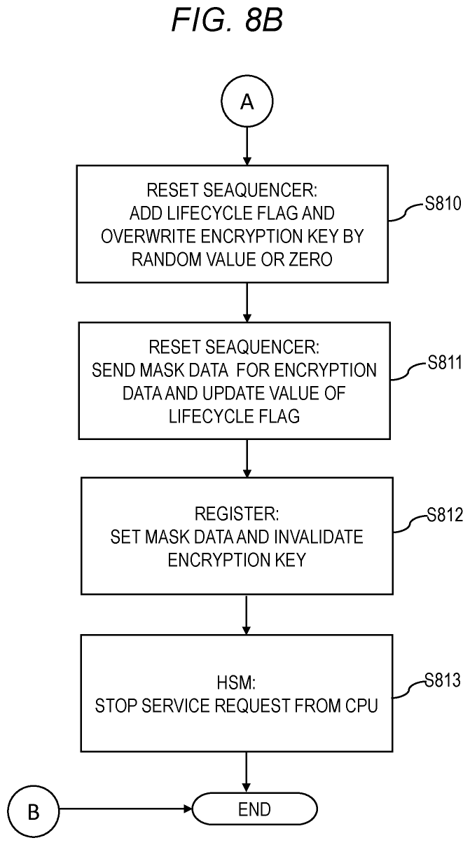

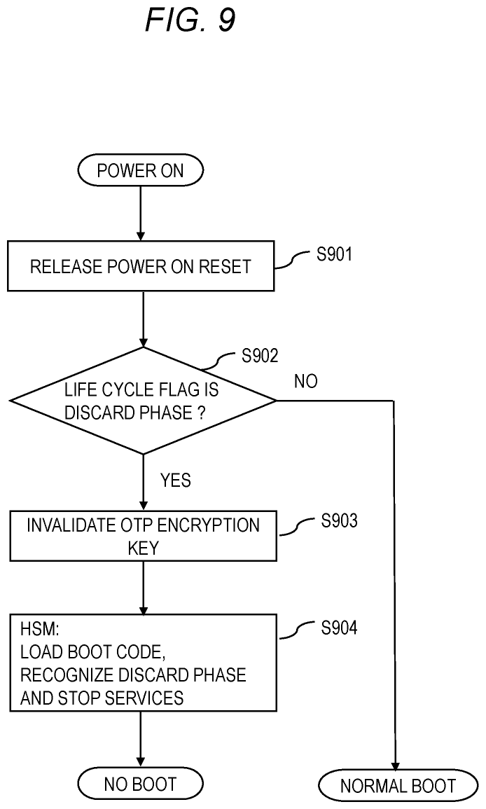

FIGS. 8A and 8B are a flowchart for moving from an operation phase to a discard phase in a semiconductor device according to the second embodiment. FIG. 9 is a flowchart of a discard phase in a semiconductor device according to the second embodiment. Referring to FIGS. 8A, 8B and 9, a method of managing secret information of the semiconductor device according to the second embodiment will be described.

In the semiconductor device according to the second embodiment, the moving from the operation phase to the disposal phase will be described. As shown in FIGS. 8A and 8B, a power supply is inputted to the semiconductor device 12 to reset release (step S801). Next, the reset sequencer 103 of the OTP module 100 recognizes that the lifecycle flag 111 of the OTP memory 101 is in the operational phase. Then, the reset sequencer 103 reads the information of the OTP memory 101 and stores the information in the register 105 in the OTP module 100 (step S802).

The register 105 transfers encryption keys and lifecycle flags to the HSM 200 over a dedicated line (step S803). The HSM 200 loads the boot code from the ROM 400 and recognizes that the lifecycle flag transferred from register 105 in the OTP module 100 is the operational phase. Thereafter, the HSM 200 performs initialization of the system of the semiconductor device 12 (step S804).

The HSM 200 expands the programming of the CPU 300 from the external storage 20 to the RAM 600 in the semiconductor device 12 and kicks the CPU 300 (step S805). The CPU 300 starts normal operation (step S806).

The CPU 300 recognizes the predetermined condition of the discard phase (step S807) and requires the HSM 200 to enter the discard phase (step S808). The HSM 200 transmits a discard phase request (step S809) to the reset sequencer 103 of the OTP module 100.

The reset sequencer 103 adds the lifecycle flag 111 of the discard phase of OTP memory 101 and overwrites the encryption key 113 with a random value or zero value (step S810). Then, the reset sequencer 103 transmits data (randomization or zeroing) to mask the encryption key stored in the register 105 and the updated value of the lifecycle flag (from the operation phase to the discard phase) to the register 105 (step S811).

The register 105 sets mask data in the mask circuit 119 and invalidates the encryption key (step S812). The register 105 also updates the lifecycle flag. Then the HSM 200 recognizes that the lifecycle flag is in the discard phase, and stops the service-request from the CPU 300, and terminates (step S813). Thus, after moving to the disposal phase, it is possible to immediately stop the operation of the semiconductor device 12.

The operation in the discard phase of the semiconductor device according to the second embodiment will be described. As shown in FIG. 9, in the discard phase, to enter the power supply to the semiconductor device 12 to reset release (step S901). Next, the reset sequencer 103 of the OTP module 100 reads the lifecycle flag 111 of the OTP memory 101 and recognizes that it is in the discard phase (step S902). Then, the reset sequencer 103 stores only the information of the lifecycle flag in the register 105 in OTP module 100 (step S903).

Here, the reset sequencer 103 may perform an invalidation of the encryption key each time it recognizes that it is in the discard phase. In this case, it is possible to recover the write failure when the power of the semiconductor device 12 is turned off during the invalidation process of the encryption key in the operation phase.

The HSM 200 loads the boot code from the ROM 400 and recognizes that the lifecycle flag transferred from the register 105 of the OTP module 100 is in the discard phase. Then the HSM 200 stops servicing from the other modules (step S904).

In this way, by implementing the invalidation of the encryption key in the hardware sequencer, the resistance to the non-invasive attack such as the fault attack can be improved. The mask circuit also prevents the use of the encryption key after moving to the discard phase, since the use of the encryption key becomes unavailable, even during the period from the request to invalidation of the encryption key to the reset.

Also, the programs described above may be stored and provided to a computer using various types of non-transitory computer readable media. Non-transitory computer readable media includes various types of tangible storage media. Examples of non-transient computer readable media include magnetic recording media (e.g., flexible disks, magnetic tapes, hard disk drives), magneto-optical recording media (e.g., magneto-optical discs), CD-ROM, CD-R, CD-R/W, solid state memories (e.g., masked ROM, PROM (Programmable ROM), EPROM (Erasable PROM, flash ROM, RAM). The programs may also be supplied to the computer by various types of transitory computer-readable transitory computer readable media. Examples of transitory computer-readable media include electrical signals, optical signals, and electromagnetic waves. The transitory computer readable medium may provide the program to the computer via wired or wireless communication paths, such as electrical wires and optical fibers.

Although the invention made by the inventor has been specifically described based on the embodiment, the present invention is not limited to the embodiment already described, and it is needless to say that various modifications can be made without departing from the gist thereof.

What is claimed is:

1. A method of managing secret information in a semiconductor device comprising an OTP (One Time Programmable) module, a security module and a processor,
the OTP module further comprising:
an OTP memory for storing a secret information and a lifecycle flag for defining an operation phase and a discard phase;
a sequencer for reading information stored in the OTP memory; and
a register for storing the information read by the sequencer,
wherein the security module performs a process by the secret information,
wherein the processor requests the process to the security module,
when changing the operation phase to the discard phase, the processor sends a request to the security module to invalidate the secret information.

2. The method of managing secret information according to claim 1,
wherein the security module writes a flag indicating the discard phase to the lifecycle flag.

3. The method of managing secret information according to claim 2,
wherein a firmware is read into the security module to invalidate the secret information and stop the semiconductor device.

4. The method of managing secret information according to claim 3,
wherein the semiconductor device has a ROM (Read Only Memory) and the firmware is stored in the ROM.

5. The method of managing secret information according to claim 4,
wherein the security module overwrites the secret information with a random value or a zero value to invalidate the secret information.

6. The method of managing secret information according to claim 5,
wherein write control to the OTP memory is invalidated so that the secret information is not overwritten in the operation phase.

7. The method of managing secret information according to claim 6,
wherein write control to the OTP memory is validated so that the secret information can be overwritten in the discard phase.

8. The method of managing secret information according to claim 5,
wherein overwriting the secret information is performed by the firmware each time the semiconductor device is powered on.

9. The method of managing secret information according to claim 8,
wherein the stop of the semiconductor device is performed by stopping subsequent processes after the security module invalidates the secret information.

10. The method of managing secret information according to claim 1,
wherein the security module sends a discard phase request to the sequencer and the sequencer writes the flag of the discard phase to the lifecycle flag to invalidate the secret information.

11. The method for managing secret information according to claim 10,
wherein the sequencer masks the secret information stored in the register and updates a lifecycle flag stored in the register.

12. The method of managing secret information according to claim 10,
wherein the secret information is invalidated by being overwritten with a random value or a zero value.

13. The method for managing secret information according to claim 12,
wherein overwriting the secret information is performed by the sequencer each time the semiconductor device is powered on.

14. The method of managing secret information according to claim 10,
when the security module recognizes moving to the discard phase and stops a service request from the processor, stop of the semiconductor device is performed.

15. A semiconductor device comprising: an OTP (One Time Programmable) module, a security module and a processor,
the OTP module further comprising:
an OTP memory for storing a secret information and a lifecycle flag for defining an operation phase and a discard phase;
a sequencer for reading information stored in the OTP memory; and
a register for storing the information read by the sequencer,
wherein the security module performs a process by the secret information,
wherein the processor requests the process to the security module,
when the processor recognizes changing the operation phase to the discard phase, the processor sends a request to the security module to invalidate the secret information to stop the semiconductor device.
